(19) United States
(12) Patent Application Publication
(10) Pub. No.: US 2020/0293878 A1
(43) Pub. Date: Sep. 17, 2020

(54) HANDLING CATEGORICAL FIELD VALUES IN MACHINE LEARNING APPLICATIONS

(71) Applicant: Expedia, Inc., Bellevue, WA (US)

(72) Inventors: Nitika Bhaskar, Redmond, WA (US); Omid Kashefi, Pittsburgh, PA (US)

(21) Appl. No.: 16/352,666

(22) Filed: Mar. 13, 2019

(51) Int. Cl. G06N 3/08; G06N 3/04; G06F 16/35

(52) U.S. Cl. CPC G06N 3/08; G06F 16/35; G06N 3/0427; G06N 3/0454

(57) ABSTRACT

Disclosed are systems and methods for handling categorical field values in machine learning applications, and particularly neural networks. Categorical field values are generally transformed into vectors prior to being passed to a neural network. However, low-dimensionality vectors limit the ability of the network to understand correlations between contextually, semantically, or characteristically similar values. High-dimensionality vectors, in contrast, can overwhelm neural networks, causing the network to seek correlations with respect to individual dimensional values, which correlations may be illusory. The present disclosure relates to a hierarchical neural network that includes a main network as well as one or more auxiliary networks. Categorical field values are processed in an auxiliary network, to reduce a dimensionality of the value before being processed by the main network. This enables contextual, semantic, and characteristic correlations to be identified without overwhelming the network as a whole.

### BACKGROUND

Generally described, machine learning is a data analysis application that seeks to automate analytical model building. Machine learning has been applied to a variety of fields, in an effort to understand data correlations that may be difficult or impossible to detect using explicitly defined models. For example, machine learning has been applied to machine learning system 118s to model how various data fields known at the time of a transaction (e.g., cost, account identifier, location of transaction, item purchased) correlate to a percentage chance that the transaction is fraudulent. Historical data correlating values for these fields and subsequent fraud rates are passed through a machine learning algorithm, which generates a statistical model. When a new transaction is attempted, values for the fields can be passed through the model, resulting in a numerical value indicative of the percentage chance that the new transaction is fraudulent. A number of machine learning models are known in the art, such as neural networks, decision trees, regression algorithms, and Bayesian algorithms.

One problem that arises in machine learning is the representation of categorical variables. Categorical variables are those variables which generally take one of a limited set of possible values, each of which denotes a particular individual or group. For example, categorical variables may include color (e.g., “green,” “blue,” etc.) or location (e.g., “Seattle,” “New York,” etc.). Generally, categorical variables do not imply an ordering. In contrast, ordinal values are used to denote ordering. For example, scores (e.g., “1,” “2,” “3,” etc.) may be an ordinal value. Machine learning algorithms are generally developed to intake numerical representations of data. However, in many instances, machine learning algorithms are formed to assume that numerical representations of data are ordinal. This leads to erroneous conclusions. For example, if the colors “green,” “blue,” and “red” were represented as values 1, 2, and 3 in a machine learning algorithm, the algorithm may assume that the average of “green” and “red” (represented as half the sum of 1 and 3) equals 2, or “blue.” This erroneous conclusion leads to errors in the output of the model.

The difficulty in representing categorical variables often stems from the dimensionality of the variable. As nominal terms, two categorical values can represent correlations in a large variety of abstract dimensions that are easy for a human to identify, but difficult to represent to a machine. For example, “boat” and “ship” are easily seen by a human as strongly correlated, but this correlation is difficult to represent to a machine. Various attempts have been made to reduce the abstract dimensionality of categorical variables into concrete numerical form. For example, a common practice is to reduce each categorical value into a single number indicative of relevance to a finally-relevant value. For example, in the fraud detection context, any name that has been associated with fraud may be assigned a high value, while names not associated with fraud may be assigned a low value. This approach is detrimental, since both a slight change in name can evade detection and since users with common names may be inaccurately accused of fraud. Conversely, where each categorical value is transformed into a multi-dimensional value (in an attempt to concretely represent the abstract dimensionality of the variable), the complexity of a machine learning model can increase rapidly. For example, a machine learning algorithm may generally treat each dimension of a value as a distinct “feature”—a value to be compared to other distinct values for correlation indicative of a given output. As the number of features of a model increases, so does the complexity of the model. However, in many cases, individual values of a multi-dimensional categorical variable cannot be individually compared. For example, if the name “John Doe” is transformed into a vector of n values, the correlation between the first of those n values and a network address from which a transaction is initiated may have no predictive value. Thus, comparing each of the n values to a network address may result in excess and inefficient compute resource usage. (In contrast, comparing the set of n values as a whole, indicative of the name “John Doe,” to a network address range, may have predictive value—if such name is associated with fraud and stems from an address in a country where fraud is prevalent, for example.) Thus, representation of categorical variables as low-dimensional values (e.g., a single value) is computationally efficient, but results in models ignoring interactions between similar categorical variables. Conversely, representation of categorical variables as high-dimensional values is computationally inefficient.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 is a block diagram illustrating a machine learning system 118 which applies a neural network machine learning algorithm to categorical variables in historical transaction data to facilitate prediction of transaction fraud.

FIGS. 2A is a block diagram depicting an illustrative generation and flow of data for initializing a fraud detection machine learning model within a networked environment, according to some embodiments.

FIG. 2B is a block diagram depicting an illustrative generation and flow of data for utilizing the machine learning system 118 within a networked environment, according to some embodiments.

FIGS. 3A-3B are visual representations of example neural network architectures utilized by the machine learning system 118, according to some embodiments.

FIG. 4 depicts a general architecture of a computing device configured to perform the fraud detection method, according to some embodiments.

FIG. 5 is a flow diagram depicting an example fraud detection method, according to some embodiments.

### DETAILED DESCRIPTION

Generally described, aspects of the present disclosure relate to efficient handling of categorical variables in machine learning models to maintain correlative information of the categorical variables while limiting or eliminating excessive computing resources required to analyze that correlative information within a machine learning model. Embodiments of the present disclosure may be illustratively utilized to detect when a number of similar categorical variable values are indicative of fraud, thus allowing detection of fraud attempts other similar categorical variable values. For example, embodiments of the present disclosure may detect a strong correlation between fraud and use of the names “John Doe” and “John Dohe,” and thus predict that use of the name “Jon Doe” is also likely fraudulent. To efficiently handle categorical variables, embodiments of the present disclosure utilize “embedding” to generate high-dimensionality numerical representations of categorical values.

Embedding is a known technique in machine learning, which attempts to reduce the dimensionality of a value (e.g., a categorical value) while maintaining important correlative information for the value. These high-dimensionality numerical representations are then processed as features of (e.g., inputs to) an auxiliary neural network. The output of each auxiliary neural network is used as a feature of a main neural network, along with other features (e.g., non-categorical variables) to result in an output, such as model providing a percentage chance that a transaction is fraudulent. By processing high-dimensionality numerical representations in separate auxiliary networks, interactions of individual dimensions of such representations with other features (e.g., non-categorical variables) are limited, reducing or eliminating excess combinatorial growth of the overall network. The outputs of each auxiliary network are constrained to represent categorical features at an appropriate dimensionality, based on the other data with which they will be analyzed. For example, two variables that are generally not semantically or contextually interrelated (such as name and time of transaction) may be processed in a main network as low dimensionality values (e.g., single values, each representing a feature of the main network). Variables that are highly semantically or contextually correlated (such as two values of a name variable) may be processed at a high-dimensionality. Variables that are somewhat semantically or contextually correlated (such as a name and email address, which may overlap in content but differ in overall form) may be processed at an intermediate dimensionality, such as by combining the outputs of two initial auxiliary networks into an intermediary auxiliary network, the output of which is then fed into a main neural network. This combination of networks can result in a hierarchical neural network. By using such a “hierarchy” of networks, the level of interactions of features on a neural network can be controlled relative to the expected semantic or contextual relevance of those interactions, thus enabling machine learning to be conducted on the basis of high-dimensionality representations of categorical variables, without incurring the excessive compute resource usage of prior models.

As noted above, to process categorical variables, an initial transformation of the variable into a numerical value is generally conducted. In accordance with embodiments of the present disclosure, embedding may be used to generate a high-dimensionality representation of a variable. As used herein, dimensionality generally refers to the quantity of numerical values used to represent a categorical value. For example, representing the color value “blue” as a numerical “1” can be considered a single-dimensional value. Representing the value “blue” as a vector “[1,0]” can be considered a two-dimensional value, etc.

One example of embedding is “word-level” embedding (also known as “word-level representation”), which attempts to transform words into multi-dimensional values, with the distance between values indicating a correlation between words. For example, the words “boat” and “ship” may be transformed into values whose distance in multi-dimensional space is low (as both relate to water craft). Similarly, a word-level embedding may transform “ship” and “mail” into values whose distance in multi-dimensional space is low (as both relate to sending parcels). However, the same word-level embedding may transform “boat” and “mail” into values whose distance in multi-dimensional space is high. Thus, word-level embedding can maintain high level correlative information of human-readable words, while representing the words in numerical form. Word-level embedding is generally known in the art, and thus will not be described in detail. However, in brief, word-level embedding often relies on prior applications of machine learning to a corpus of words. For example, machine learning analysis performed on published text may indicate that “dog” and “cat” frequently appear close to the word “pet” in text, and are thus related. Thus, the multi-dimensional representation of “dog” and “cat” according to the embedding may be close within multi-dimensional space. One example of a word-level embedding algorithm is the “word2vec” algorithm developed by GOOGLE™, which takes as input a word, and produces a multi-dimensional value (a “vector”) that attempts to preserve contextual information regarding the word. Other word-level embedding algorithms are known in the art, any of which may be utilized in connection with the present disclosure. In some embodiments, word-level embedding may be supplemented with historical transaction data to determine contextual relationships between particular words in the context of potentially-fraudulent transactions. For example, a corpus of words may be trained in a neural network along with data indicating a correspondence of words and associated fraud (e.g., from historical records that indicate use of each word in a data field of a transaction, and whether the transaction was eventually determined to be fraudulent. The output of the neural network may be a multi-dimensional representation that indicates the contextual relationship of words in the context of transactions, rather than in a general corpus. In some instances, training of a network determining word-level embeddings occurs prior to and independently training a fraud detection model as described herein. In other instances, training of a network to determine word level embeddings occurs simultaneously to training a fraud detection model as described herein. For example, the neural network training to provide word-level embeddings may be represented as an auxiliary network to a hierarchical neural network.

Another example of embedding is “character-level” embedding (also known as “character-level representation”), which attempts to transform words into multi-dimensional values representative of the individual characters in the word (as opposed to representative of the semantic use of a word, as in word-level embedding). For example, character level embedding may transform the words “hello” and “yellow” into values close by one another in multi-dimensional space, given the overlapping characters and general structure of the words. Character-level embedding may be useful to capture small variations in categorical values that are uncommon (or unused) in common speech. For example, the two usernames “johnpdoe” and “jonhdoe” may not be represented in a corpus, and thus word-level embedding may be insufficient to represent the usernames. However, character-level embedding would likely transform both usernames into similar multi-dimensional values. Like word-level embedding, character-level embedding is generally known in the art, and thus will not be described in detail. One example of a word-level embedding algorithm is the “seq2vec” algorithm which takes as input a string, and produces a multi-dimensional value (a “vector”) that attempts to preserve contextual information regarding objects within the string. While the seq2vec model is often applied similarly to “word2vec,” to describe contextual information between words, the model may also be trained to identify individual characters as objects, thus finding contextual information between characters. In this manner, character-level embedding models can be viewed similarly to word-level embedding models, in that the models take as input a corpus of strings (e.g., a general corpus of words in a given language, a corpus of words used on the context of potentially-fraudulent transactions, etc.) and outputs a multi-dimensional representation that attempts to preserve contextual information between the characters (e.g., such that characters that appear near to one-another in the corpus are assigned vector values near to one-another in multidimensional space). Other word-level embedding algorithms are known in the art, any of which may be utilized in connection with the present disclosure.

After obtaining a high-dimensionality representation of each value for a given categorical variable (e.g., a name of a person that has made a transaction), these representations can be passed into an auxiliary neural network in order to generate outputs (e.g., neurons), which outputs are in turn used as features for a subsequent neutral network (e.g., an intermediate network or a main network). A separate auxiliary network may be established for each categorical variable (e.g., name, email address, location, etc.), and the outputs of each categorical variable may be constrained relative to the number of inputs, which inputs generally equal the number of dimensions in a high-dimensionality representation of the variable values. For example, where a name is represented as a 100-dimension vector, an auxiliary network may take the 100-dimensions of each name as 100 input values, and produce a 3 to 5 neuron output. These outputs effectively represent a lower-dimensionality representation of the categorical variable value, which can be passed into a subsequent neural network. The outputs of a main network is established as the desired result (e.g., a binary classification of whether a transaction is or is not fraud). The auxiliary and main network are then concurrently trained, enabling the outputs of the auxiliary network represent a low-dimensionality representation that is specific to the desired output (e.g., a binary classification as fraudulent or non-fraudulent or multi-class classification with types of fraud/abuse), rather than a generalized low-dimensionality representation that would be achieved by embedding (which relies on an established, rather than concurrently trained, model). Thus, the low-dimensionality representation of a categorical variable produced by an auxiliary neural network is expected to maintain semantic or contextual information relevant to a desired final result, without requiring the high-dimensionality representation to be fed into a main model (which would otherwise incur the costs associated with attempting to model one or more high-dimensionality representations in a single model, as noted above). Advantageously, utilizing the lower-dimensionality output of the auxiliary network with the main network allows a user to test the interactions and correlations of categorical variables with non-categorical variables using fewer computing resources in comparison to existing methods.

As will be appreciated by one of skill in the art in light of the present disclosure, the embodiments disclosed herein improves the ability of computing systems to conduct machine learning related to categorical variables in an efficient manner. Specifically, embodiments of the present disclosure increase the efficiency of computing resource usage of such systems by utilizing a combination of a main machine learning model and one or more auxiliary models, which auxiliary models enable processing of categorical variables as high-dimensionality representations while limiting interactions of those high-dimensionality representations with other features passed to the main model. Moreover, the presently disclosed embodiments address technical problems inherent within computing systems; specifically, the limited nature of computing resources with which to conduct machine learning, and the inefficiencies caused by attempting to conduct machine learning on high-dimensionality representations of categorical variables within a main model. These technical problems are addressed by the various technical solutions described herein, including the use of auxiliary models to process high-dimensionality representations of categorical variables and provide outputs as features to a main model. Thus, the present disclosure represents an improvement on existing data processing systems and computing systems in general.

While embodiments of the present disclosure are described with reference to specific machine learning models, such as neural networks, other machine learning models may be utilized in accordance with the present disclosure.

The foregoing aspects and many of the attendant advantages of this disclosure will become more readily appreciated as the same become better understood by reference to the following description, when taken in conjunction with the accompanying drawings.

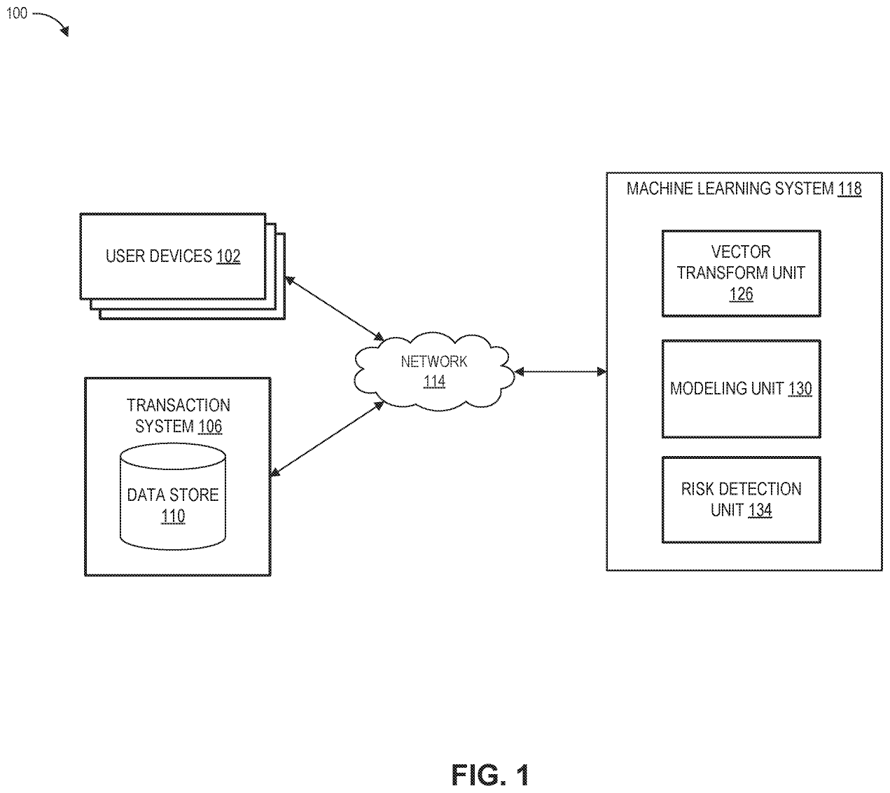

FIG. 1 is a block diagram illustrating an environment 100 in which a machine learning system 118 which applies a neural network machine learning algorithm to categorical and non-categorical variables in historical data to facilitate classification of later data. Specifically, the machine learning system 118 processes historical data by generating a neural network model including both a main network and auxiliary networks, which auxiliary networks process high-dimensionality representations of categorical variables prior passing an output to the main network. In an illustrative embodiment, the machine learning system 118 processes historical transaction data to generate a binary classification of new proposed transactions as fraudulent or not fraudulent. However, in other embodiments, other types of data may be processed to generate other classifications, including binary or non-binary classifications. For example, multiple output nodes of a main network may be configured such that the network outputs values for use in a multiple classification system. The environment 100 of FIG. 1 is depicted as including a client devices 102, a transaction system 106, and a machine learning system 118 which may all be in communication with each other via network 114.

The transaction system 106 illustratively represents a network-based transaction facilitator, which operates to service requests from clients (via client devices 102) to initiate transactions. The transactions may illustratively be purchases or acquisitions of physical goods, non-physical goods, services, etc. Many different types of network-based transaction facilitators are known within the art. Thus, the details of operation of the transaction system 106 may vary across embodiments, and are not discussed herein. However, for the purposes of discussion, it is assumed that the transaction system 106 maintains historical data correlating various fields related to a transaction with a final outcome of the transaction (e.g., as fraudulent or non-fraudulent). The fields of each transaction may vary, and may include fields such as a time of transaction, and amount of the transaction, fields identifying one or more parties to the transaction (e.g., name, birth date, account identifier or username, email address, mailing address, internet protocol (IP) address, etc.), the items to which the transaction pertains (e.g. characteristics of the items, such as the departure and arrival airports for a flight purchased, a brand of item purchased, etc.), payment information for the transaction (e.g., type of payment instrument or a credit card number used), or other constraints on the transaction (e.g., whether the transaction is refundable). Outcomes of each transaction may be determined by monitoring those transactions after they have completed, such as by monitoring “charge-backs” to transactions later reported as fraudulent by an impersonated individual. The historical transaction data is illustratively stored in a data store 110, which may be a hard disk drive (HDD), solid state drive (SSD), network attached storage (NAS), or any other persistent or substantially persistent data storage device.

Client devices 102 generally represent devices that interact with the transaction system in order to request transactions. For example, the transaction system 106 may provide user interfaces, such as graphical user interfaces (GUIs) through which clients, using client devices 102, may submit a transaction request and data fields associated with the request. In some instances, data fields associated with a request may be determined independently by the transaction system 106 (e.g., by independently determining a time of day, by referencing profile information to retrieve data on a client associated with the request, etc.). Client devices 102 may include any number of different computing devices. For example, individual client devices 102 may correspond to a laptop or tablet computer, personal computer, wearable computer, personal digital assistant (PDA), hybrid PDA/mobile phone, or mobile phone.

Client devices 102 and the transaction system 106 may interact via a network 114. The network 114 may be any wired network, wireless network, or combination thereof. In addition, the network 114 may be a personal area network, local area network, wide area network, global area network (such as the Internet), cable network, satellite network, cellular telephone network, or combination thereof. While shown as a single network 114, in some embodiments the elements of FIG. 1 may communicate over multiple, potentially distinct networks.

As discussed above, it is often desirable for transaction systems 106 to detect fraudulent transactions prior to finalizing the transaction. Thus, in FIG. 1, the transaction system 106 is depicted as in communication with the machine learning system 118, which operates to assist in detection of fraud by generation of a fraud detection model. Specifically, the machine learning system 118 is configured to utilize auxiliary neural networks to process high-dimensionality representations of categorical variables, the output of which are used as features of a main neural network, whose output in turn represents a classification of a transaction as fraudulent or non-fraudulent (which classification may be modeled, for example, as a percentage chance that fraud is occurring). To facilitate generation of a model, the machine learning system includes a vector transform unit 126, modeling unit 130, and risk detection unit 134. The vector transformation unit 126 can comprise computer code that operates to transform categorical field values (e.g., names, email addresses, etc.) into high-dimensionality numerical representations of those field values. Each high-dimensionality numerical representations may take the form of a set of numerical values, referred to generally herein as a vector. In one embodiment, categorical field values are transformed into numerical representations by use of embedding techniques, such as word-level or character-level embedded, as discussed above. The modeling unit 130 can represent code that operates to generate and train a machine learning model, such as a hierarchical neural network, wherein the high-dimensionality numerical representations are first passed through one or more auxiliary neural networks before being passed to a main network. The trained model may then be utilized by the risk detection unit 134, which can comprise computer code that operates to pass new field values for an attempted transaction into the trained model to result in a classification as to the likelihood that the transaction is fraudulent.

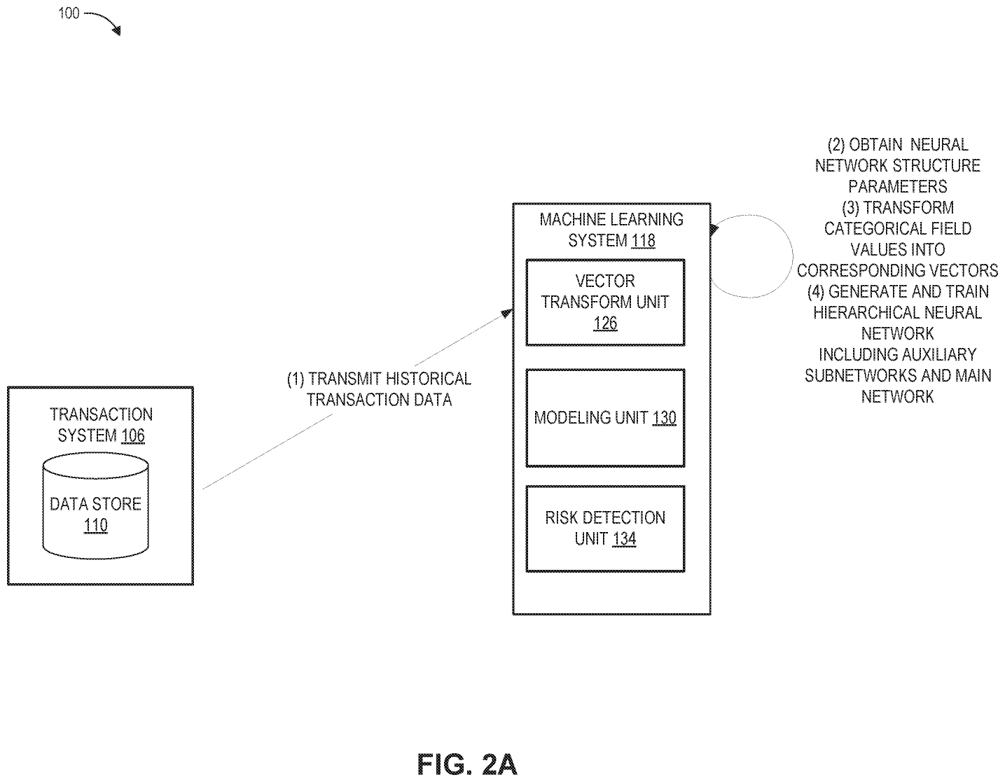

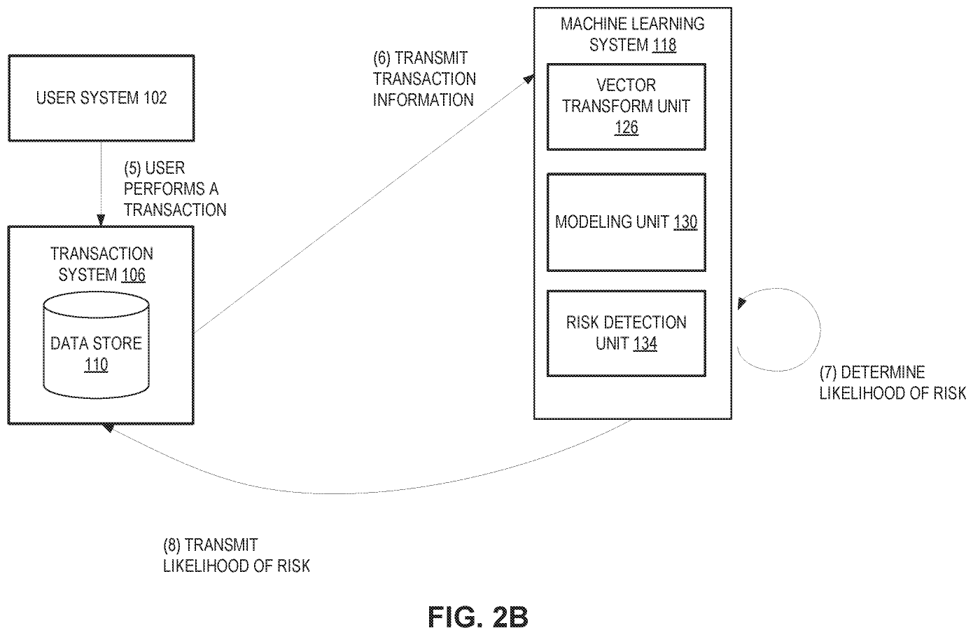

With reference to FIGS. 2A-2B illustrative interactions will be described for operation of the machine learning system 118 to generate, train, and utilize a hierarchical neural network, including one or more auxiliary networks whose output is used as features to a main neural network. Specifically, FIG. 2A depicts illustrative interactions used to generate and train such a hierarchical neural network, while FIG. 2B depicts illustrative interactions to use the trained network to predict a likelihood of fraud of an attempted transaction.

The interactions begin at (1), where the transaction system 106 transmits to machine learning system 118 historical transaction data. In some embodiments, the historical transaction data may comprise raw data of past transactions that have been processed or submitted to the transaction system 106. For example, the historical data may be a list of all transactions made on the transaction system 106 over the course of a three-month period, as well as fields related to the transaction, such as such as a time of transaction, and amount of the transaction, fields identifying one or more parties to the transaction (e.g., name, birth date, account identifier or username, email address, mailing address, interne protocol (IP) address, etc.), the items to which the transaction pertains (e.g. characteristics of the items, such as the departure and arrival airports for a flight purchased, a brand of item purchased, etc.), payment information for the transaction (e.g., type of payment instrument or a credit card number used), or other constraints on the transaction (e.g., whether the transaction is refundable). The historical data is illustratively “tagged” or labeled with an outcome of the transaction with respect to a desired categorization. For example, each transaction can be labelled as “fraudulent” or “not fraudulent.” In some embodiments, the historical data may be stored and transmitted in the form of a text file, a tabulated spreadsheet, or other data storage format.

At (2), the machine learning system 118 obtains neural network hyperparameters for the desired neural network. The hyperparameters may be specified, for example, by an operator of the transaction system 106 or machine learning system 118. In general, the hyperparameters may include those fields within the historical data that should be treated as categorical, as well as an embedding to apply to the field values. The hyperparameters may further include an overall desired structure of the neural network, in terms of auxiliary networks, a main network, and intermediary networks (if any). For example, the hyperparameters may specify, for each categorical field, a number of hidden layers for an auxiliary network associated with the categorical field and number of units in such layers, and a number of output neurons for that auxiliary network. The hyperparameters may similarly specify a number of hidden layers for the main network, a number of units in each such layer, and other non-categorical features to be provided to the main network. If intermediary networks are to be utilized between the outputs of auxiliary networks and the inputs (“features”) of the main network, the hyperparameters may specify the structure of such intermediary networks. A variety of additional hyperparameters known in the art with respect to neural networks may also be specified.

At (3), the machine learning system 118 (e.g., the vector transform unit 126) transforms categorical field values from the historical data into corresponding high-dimensionality numerical representations (vectors), as specified by the hyperparameters. Illustratively, values of each categorical field may be processed according to at least one of word-level embedding or character-level embedding, described above, to transform a string representation of the field value into a vector. While a single embedding for a given categorical field is illustratively described, in some instances, the same field by be represented by different embeddings, each of which is passed to a different auxiliary neural network. For example, a name field may be represented by both word- and character-level embeddings, in order to assess both semantic/contextual information (e.g., repeated use of words meaning similar things) and character-relation information (e.g., slight variations in the characters used for a name).

Thereafter, at (4), the machine learning system 118 (e.g., via the modeling unit 130) generates and trains the neural network according to the hyperparameters. Illustratively, for each categorical field specified within the hyperparameters, the modeling unit 130 may generate an auxiliary network taking as an input the values within a vector representation of a field value and providing as output a set of nodes that serve as inputs to a later network. The number of nodes output by each auxiliary network may be specified within the hyperparameters, and may generally be less than the dimensionality of the vector representation taken in by the auxiliary network. Thus, the output of the set of nodes may itself be viewed as a lower-dimensionality representation of a categorical field value. The modeling unit 130 may combine the outputs of each auxiliary network in a manner specified within the hyperparameters. For example, the outputs of each auxiliary network may be used directly as inputs to a main network, or may be used as outputs to one or more intermediary networks whose outputs in turn are inputs to the main network. The modeling unit 130 may further provide as inputs to the main network one or more non-categorical fields.

After generating the network structure, the modeling unit 130 may train the network utilizing at least a portion of the historical transaction data. General training of defined neural network structures is known in the art, and thus will not be described in detail herein. However, in brief, the modeling unit 130 may, for example, divide the historical data into multiple data sets (e.g., training, validation, and test sets) and process the data sets using the hierarchical neural network (the overall network, including auxiliary, main, and any intermediary networks) to determine weights applied at each node to input data. As an end result, a final model may be generated that takes as input fields from a proposed transaction, and results as an output the probability that the fields will be placed into a given category (e.g., fraudulent or non-fraudulent).

FIG. 2B is a block diagram depicting an illustrative generation and flow of data for utilizing the machine learning system 118 within a networked environment, according to some embodiments. The data flow may begin when (5) a user, through client devices 102, requests initiation of a transaction on transaction system 106. For example, a user may attempt to purchase an item from a commercial retailer's online website. To aid in a determination as to whether to allow the transaction, the transaction system 106 submits the transaction information (e.g., including the fields discussed above) to the machine learning system 118, at (6). The machine learning system 118 (e.g., via the risk detection unit 134) may then apply the previously learned model to the transaction information, to obtain a likelihood that the transaction is fraudulent. At (8), the machine learning system 118 transmits the final risk score to the transaction system 106, such that the transaction system 106 can determine whether or not to allow the transaction. Illustratively, the transaction system may establish a threshold likelihood, such that any attempted transaction above the threshold is rejected or held for further processing (e.g., human or automated verification),

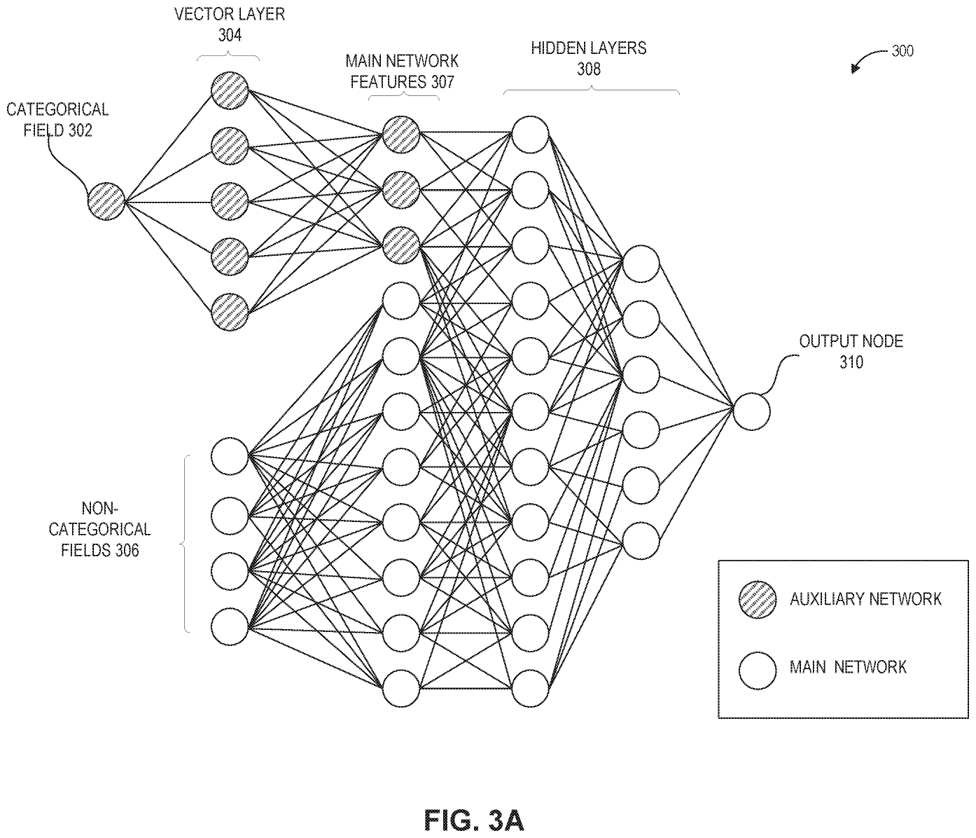

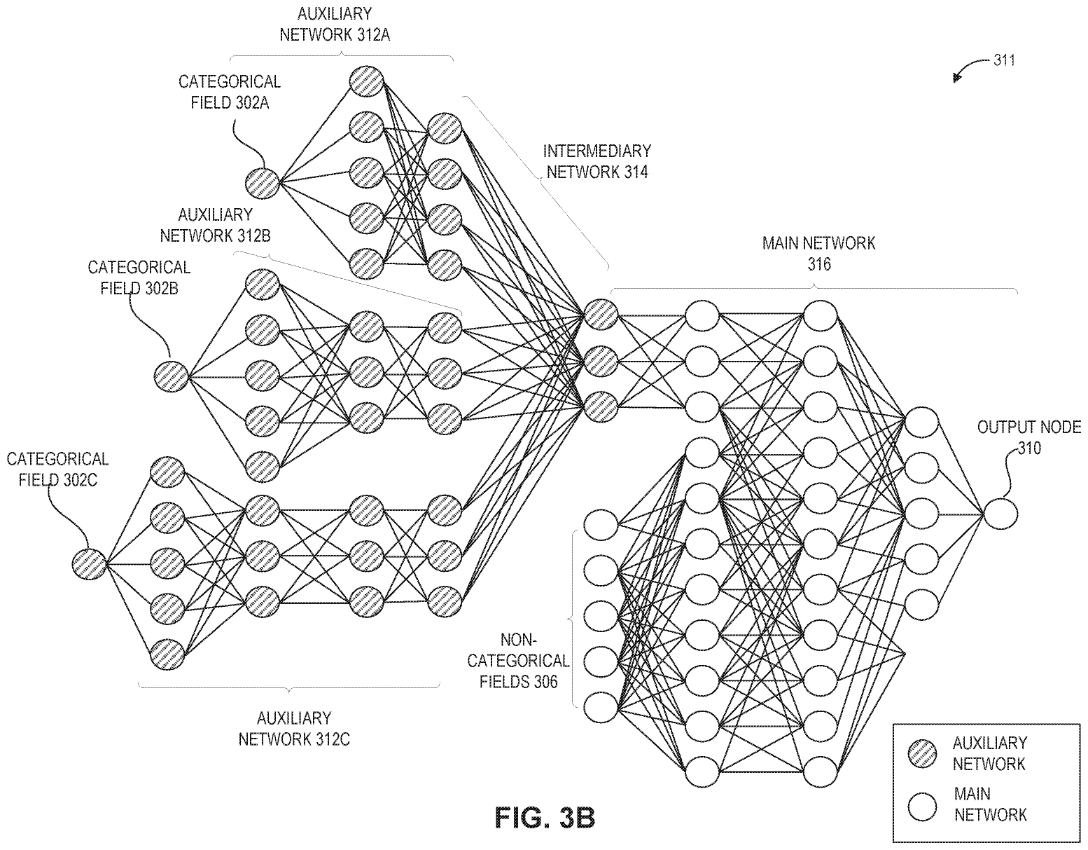

FIGS. 3A-3B are visual representations of example hierarchical neural network that may be generated and trained by the machine learning system 118 based at least partly on examining historical data over a period of time, according to some embodiments. Specifically, FIG. 3A depicts a hierarchical neural network with a single auxiliary network joined to a main network. FIG. 3B depicts a hierarchical neural network with multiple auxiliary networks, an intermediary network, and a main network.

Specifically, in FIG. 3A, an example hierarchical neural network 300 is shown that includes a single categorical field (e.g., a “name” field) that is processed through an auxiliary network (shown as shaded nodes), the output of which is passed as an input (or feature) into a main network. The auxiliary network includes an input node 302 that corresponds to a value of the categorical field (e.g., “John Doe” for one transaction entry). The auxiliary network further includes a vector layer 304 representing the value for the categorical field as transformed via an embedding into a multi-dimensional vector. Each node within the vector layer 304 illustratively represents a single numerical value within the vector created by applying embedding to the value of the categorical field. Thus, in FIG. 3A, embedding a categorical field value may result in a 5-dimensional vector, individual values of which are passed to individual nodes in the vector layer 304. In practice, categorical field values may be transformed into very high-dimensionality vectors (e.g., 100 or more dimensions), and thus the vector layer 304 may have many more nodes than depicted in FIG. 3A. While input node 302 is shown for completeness, in some instances the auxiliary network may exclude the input node, as categorical field values may have been previously transformed into vectors. Thus, the vector layer 304 may act as an input layer to the auxiliary network.

In addition, the hierarchical network 300 includes a main network (shown as unshaded nodes). The outputs of the auxiliary network represent inputs, or features 307, to the main network. In addition, the main network takes a set of additional features from non-categorical fields 306 (which may be formed, for example, by an operator-defined transformation of the non-categorical field values). The main network features 307 are passed through the hidden layers 308 to arrive at the output node 310. In some embodiments, the output 310 is a final score indicating the likelihood of fraud given a categorical field value 302 and other non-categorical field values 306 (e.g., price of a transaction, time of the transaction, or other numerical data).

As shown in FIG. 3A, the number of outputs of the auxiliary neural network can be selected to be low relative to the size of the vector layer 304. In one embodiment, the outputs of the auxiliary network are set to between three to five neurons. Utilizing an auxiliary network with low-dimensionality output may reduce the overall complexity of the network 300, relative to other techniques for incorporating categorical fields into the network 300. For example, in conventional neural network architectures that rely on simple embedding and concatenation, one might transform a categorical value via embedding into a 50-dimension vector, and concatenate that vector with other features of a network, resulting in the addition of 50 features to the network. As the number of features grows, so does the complexity of the network, and time required to generate and train the network. Thus, particularly in instances where multiple categorical values are considered, concatenation can be impractical an inefficient. This inefficiency is exacerbated by the configuration of neural networks to consider features independently, rather than as a group. Thus, the addition of a vector as 50 features would unnecessarily cause a network to seek correlations between those 50 features individually and other non-categorical features—correlations which may be illusory.

In contrast to traditional neural network techniques that rely on simple embedding and concatenation of the categorical features with other non-categorical features, the network 300 will not concatenate the vector representation of the categorical field with other non-categorical features, but will instead process the categorical field via the auxiliary network. By avoiding traditional concatenation, the network 300 may maintain the whole vector as a semantic unit and will not lose the semantic relation by treating each number in the vector individually. Advantageously, the network 300 may avoid learning unnecessary and meaningless interactions between each of the numbers and inadvertently impose unnecessary complexity and invalid relation and interaction mapping.

FIG. 3B depicts an example hierarchical neural network 311 with multiple auxiliary networks 312, an intermediary network 314, and a main network 316. Many elements of the network 311 are similar to the network 300 of FIG. 3A, and thus will not be redescribed. However, in contrast to the network 300, the network 311 of FIG. 3B includes three auxiliary networks, networks 312A-312C. Each network illustratively corresponds to a categorical field, which is transformed via embedding to a high-dimensionality vector, before being reduced in dimensionality through the respective auxiliary networks 312. The outputs of the auxiliary networks 312 are used as inputs to an intermediary network 314, which again reduces the dimensionality of the outputs. The use of an intermediary network 314 may be beneficial, for example, to enable detection of correlations between multiple categorical field values, without attempting to detect correlations with non-categorical field values. For example, the intermediary network 314 may be used to detect higher-level correlations between a user's name, email address, and mailing address (e.g., such that when these three fields correlate in a certain manner, fraud is more or less likely). The output of the intermediary network 314 generally loses information relative to the inputs to that network 314, and thus the main network need not attempt to detect higher-level correlations between a user's name and other non-categorical fields (e.g., transaction amount). Thus, the hierarchical network 311 enables the interactions of different fields to be controlled, limiting the network to inspect only those correlations that are expected to be relevant rather than illusory.

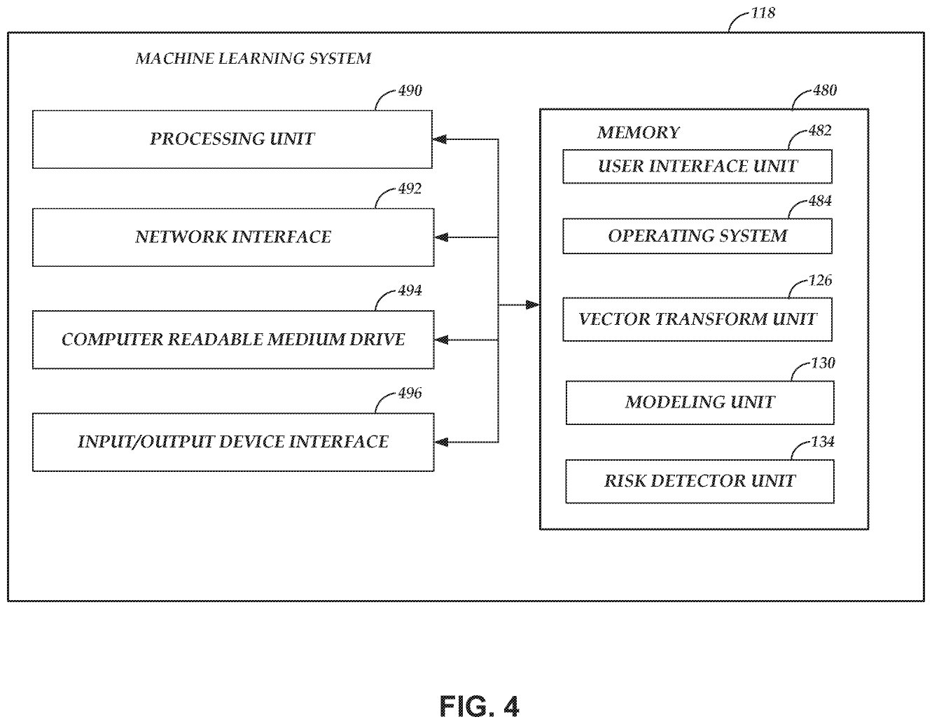

FIG. 4 depicts a general architecture of a computing device configured to perform the fraud detection method, according to some embodiments. The general architecture of the machine learning system 118 depicted in FIG. 4 includes an arrangement of computer hardware and software that may be used to implement aspects of the present disclosure. The hardware may be implemented on physical electronic devices, as discussed in greater detail below. The machine learning system 118 may include many more (or fewer) elements than those shown in FIG. 4. It is not necessary, however, that all of these generally conventional elements be shown in order to provide an enabling disclosure. Additionally, the general architecture illustrated in FIG. 4 may be used to implement one or more of the other components illustrated in FIG. 1.

As illustrated, the machine learning system 118 includes a processing unit 490, a network interface 492, a computer readable medium drive 494, and an input/output device interface 496, all of which may communicate with one another by way of a communication bus. The network interface 492 may provide connectivity to one or more networks or computing systems. The processing unit 490 may thus receive information and instructions from other computing systems or services via the network 114. The processing unit 490 may also communicate to and from memory 480 and further provide output information for an optional display (not shown) via the input/output device interface 496. The input/output device interface 496 may also accept input from an optional input device (not shown).

The memory 480 can contain computer program instructions (grouped as units in some embodiments) that the processing unit 490 executes in order to implement one or more aspects of the present disclosure. The memory 480 correspond to one or more tiers of memory devices, including (but not limited to) RAM, 3D XPOINT memory, flash memory, magnetic storage, and the like.

The memory 480 may store an operating system 484 that provides computer program instructions for use by the processing unit 490 in the general administration and operation of the machine learning system 118. The memory 480 may further include computer program instructions and other information for implementing aspects of the present disclosure. For example, in one embodiment, the memory 480 includes a user interface unit 482 that generates user interfaces (and/or instructions therefor) for display upon a computing device, e.g., via a navigation and/or browsing interface such as a browser or application installed on the computing device.

In addition to and/or in combination with the user interface unit 482, the memory 480 may include a vector transform unit 126 configured to transform categorical field into vector representations. The vector transform unit 126 may include lookup tables, mappings, or the like to facilitate these transforms. For example, where the vector transform unit 126 implements the word2vec algorithm, the unit 126 may include a lookup table enabling conversion of individual words within a dictionary to corresponding vectors, which lookup table may be generated by a separate training of the word2vec algorithm against a corpus of words. The unit 126 may include similar lookup tables or mapping to facilitate character-level embedding, such as tables or mappings generated by implementation of the seq2vec algorithm.

The memory 480 may further include a modeling unit 130 configured to generate and train a hierarchal neural network. The memory 480 may also include a risk detection unit 134 to pass transaction data through the trained machine learning model to detect fraud.

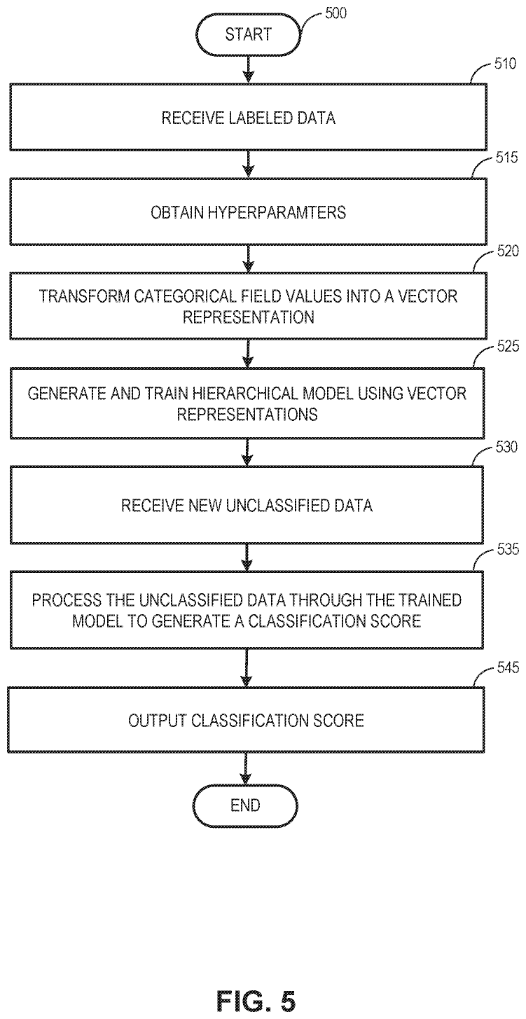

FIG. 5 is a flow diagram depicting an example routine 500 for handling categorical field values in machine learning applications by use of auxiliary networks. The routine 500 may be carried out by the machine learning system 118 of FIG. 1, for example. More particularly, the routine 500 depicts interactions for generating and training a hierarchical neural network to classify an event or item. In the context of FIG. 5, the routine 500 will be described with reference to classifying a transaction as fraudulent or non-fraudulent, based on historical transaction data. However, other types of data may also be processed via the routine 500.

The routine 500 begins at block 510, where the machine learning system 118 receives labeled data. The labeled data may include for example a listing of past transactions from transaction system 106, labeled according to whether the transaction was fraudulent. In some embodiments, the historical data may comprise past records of all transactions that have occurred through transaction system 106 over a period of time (e.g., over the past 12 months).

The routine 500 then continues to block 515, where the system 118 obtains hyperparameters for a hierarchical neural network to be trained based on the labeled data. The hyperparameters may include, for example, indication of which fields of the labeled data are categorical, and an appropriate embedding to be applied to the categorical field values to result in high-dimensionality vectors. The hyperparameters may further include a desired structure of an auxiliary network to be created for each categorical value, such as a number of hidden layers or output nodes to be included in each auxiliary network. Furthermore, the hyperparameters may specify a desired hierarchy of the hierarchical neural network, such as whether one or more of the auxiliary networks should be merged via an intermediary network before being passed to the main network, and the size and structure of the intermediary network. The hyperparameters may also include parameters for the main network, such as a number of hidden layers and a number of nodes in each layer.

At block 520, the machine learning system 118 transforms the categorical field values (as represented in the labeled data) into vectors, as instructed within the hyperparameters. Implementation of block 520 may include embedding the field values according to predetermined transformations. In some instances, these transformations may occur during training of the hierarchical network, and thus implementation of block 520 as a distinct block may be unnecessary.

At block 525, the machine learning system 118 generates and trains a hierarchical neural network, including an auxiliary network for each categorical field value identified within the hyperparameters, a main network, and (if specified within the hyperparameters) an intermediary network. Examples, of models that may be generated are shown in FIG. 3A and 3B, discussed above. In one embodiment, the network is procedurally generated based on the hyperparameters, by initially generating auxiliary networks for each categorical value, merging the outputs of those auxiliary networks via an intermediary network (if specified within the hyperparameters), and combining the outputs of the auxiliary networks (or alternatively one or more intermediary networks) with non-categorical feature values as inputs to a main network. Thus, while the hyperparameters may specify overall structural considerations for the hierarchical network, the network itself in some instances need not be explicitly modeled by a human operator. After generating the network, the machine learning system 118 trains the network via the labeled data, in accordance with traditional neural network training. As a result, a model is generated that for a given record of input fields, produces a classification value as an output (e.g., a risk that a transaction is fraudulent).

Once the machine learning model has been generated and trained in block 525, the machine learning system 118 at block 530 receives a new transaction data. In some embodiments, the new transaction data may correspond to a new transaction instigated by a user on transaction system 106, which the transaction system 106 transmits to the machine learning system 118 for review. At block 535, the system 118 processes the received data via the generated and trained hierarchical model to generate classification value (e.g., a risk that a transaction is fraudulent). At block 545, the system 118 then outputs the classification value (e.g., to the transaction system 106). Thus, the transaction system 106 may utilize the classification value to determine whether, for example, to permit or deny a transaction. The routine 500 then ends.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or one or more computer processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a similarity detection system, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A similarity detection system can be or include a microprocessor, but in the alternative, the similarity detection system can be or include a controller, microcontroller, or state machine, combinations of the same, or the like configured to estimate and communicate prediction information. A similarity detection system can include electrical circuitry configured to process computer-executable instructions. Although described herein primarily with respect to digital technology, a similarity detection system may also include primarily analog components. For example, some or all of the prediction algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a similarity detection system, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An illustrative storage medium can be coupled to the similarity detection system such that the similarity detection system can read information from, and write information to, the storage medium. In the alternative, the storage medium can be integral to the similarity detection system. The similarity detection system and the storage medium can reside in an ASIC. The ASIC can reside in a user terminal. In the alternative, the similarity detection system and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system to handle categorical field values in machine learning applications comprising:
a data store comprising labeled transaction records, each record corresponding to a transaction and including values for individual fields within a set of fields related to the transaction and labeled with an indication of whether the transaction was determined to be fraudulent;
one or more processors configured with computer-executable instructions to at least:
obtain hyperparameters for a hierarchical neural network, the hyperparameters identifying at least a categorical field within the set of fields and an embedding process to be used to transform values of the categorical field into multi-dimensional vectors;
generate the multi-dimensional vectors for the categorical field by transforming field values of the categorical field within the records according to the embedding process;
generate an auxiliary neural network that takes as input the multi-dimensional vectors and outputs, for each vector, a lower-dimensionality representation of the vector;
generate a hierarchical neural network comprising at least the auxiliary neural network and a main neural network, wherein the main neural network takes as input a combination of the lower-dimensionality representations output by the auxiliary neural network and one or more values of a non-categorical field within the set of fields, and wherein the main neural network outputs a binary classification indicating a likelihood that an individual transaction corresponding to an input record is fraudulent;
train the hierarchical neural network according to the labeled transaction data to result in a trained model;
process a new transaction record according to the trained model to determine a likelihood that the new transaction is fraudulent; and
output the likelihood that the new transaction is fraudulent.

2. The system of claim 1, wherein the categorical field represents at least one of names, usernames, email addresses or mailing addresses of parties to each transaction.

3. The system of claim 1, wherein the non-categorical field represents ordinal or numerical values for each transaction.

4. The system of claim 3, wherein the ordinal values comprise at least one of transaction amounts or times of transactions.

5. The system of claim 1, wherein the embedding process represents at least one of word-level or character-level embedding.

6. A computer-implemented method comprising:
obtaining labeled transaction records, each record corresponding to a transaction and including values for individual fields within a set of fields related to the transaction and labeled with an indication of whether the transaction was determined to be fraudulent;
obtaining hyperparameters for a hierarchical neural network, the hyperparameters identifying at least a categorical field within the set of fields and an embedding process to be used to transform values of the categorical field into multi-dimensional vectors;
generating the multi-dimensional vectors;
generating a hierarchical neural network comprising at least an auxiliary neural network and a main neural network, wherein:
the auxiliary neural network that takes as input the multi-dimensional vectors and outputs, for each vector, a lower-dimensionality representation of the vector; and
the main neural network takes as input a combination of the lower-dimensionality representations output by the auxiliary neural network and one or more values of a non-categorical field within the set of fields, and wherein the main neural network outputs a binary classification indicating a likelihood that an individual transaction corresponding to an input record is fraudulent;
training the hierarchical neural network according to the labeled transaction records to result in a trained model;
processing a new transaction record according to the trained model to determine a likelihood that the new transaction is fraudulent; and
outputting the likelihood that the new transaction is fraudulent.

7. The computer-implemented method of claim 6, wherein the hyperparameters identify one or more additional categorical fields within the set of fields, and wherein the hierarchical neural network comprises an additional auxiliary neural network for each of the one or more additional categorical fields, the outputs of each additional auxiliary neural network representing additional inputs to the main neural network.

8. The computer-implemented method of claim 7, wherein the lower-dimensionality representation is represented by a set of output neurons of the auxiliary neural network.

9. The computer-implemented method of claim 7, wherein generating the multi-dimensional vectors comprises, for each value of the categorical field, referencing a lookup table identifying a corresponding multi-dimensional vector.

10. The computer-implemented method of claim 7, wherein the lookup table is generated by a prior application of a machine learning algorithm to a corpus of values for the categorical field.

11. The computer-implemented method of claim 7, wherein the hierarchical neural network further comprises an intermediary neural network provides the lower-dimensionality representations output by the auxiliary neural network to the main neural network.

12. The computer-implemented method of claim 11, wherein the intermediary neural network further reduces a dimensionality of the lower-dimensionality representations output by the auxiliary neural network prior to providing the lower-dimensionality representations to the main neural network.

13. The computer-implemented method of claim 7, wherein the embedding process represents at least one of word-level or character-level embedding.

14. Non-transitory computer-readable media comprising computer-executable instructions that, when executed by a computing system, cause the computing system to:
obtain labeled records, each record including values for individual fields within a set of fields and labeled with a classification for the record;
obtain hyperparameters for a hierarchical neural network, the hyperparameters identifying at least a categorical field within the set of fields and an embedding to be used to transform values of the categorical field into multi-dimensional vectors;
generate a hierarchical neural network comprising at least an auxiliary neural network and a main neural network, wherein:
the auxiliary neural network that takes as input multi-dimensional vectors for the categorical field within the set of fields, the multi-dimensional vectors resulting from a transformation of values for the categorical field according to an embedding process, and wherein the auxiliary neural network outputs, for each multi-dimensional vector, a lower-dimensionality representation of the multi-dimensional vector; and
the main neural network takes as input a combination of the lower-dimensionality representations output by the auxiliary neural network and one or more values of a non-categorical field within the set of fields, and wherein the main neural network outputs a binary classification for an input record;
train the hierarchical neural network according to the labeled records to result in a trained model;
process a new record according to the trained model to determine a classification for the new record; and
output the classification for the new record.

15. The non-transitory computer-readable media of claim 14, wherein the categorical field represents qualitative values and the non-categorical field represents quantitative values.

16. The non-transitory computer-readable media of claim 14, wherein the hierarchical neural network is structured to prevent, during training, identification of correlations between values of the non-categorical field and individual values of the multi-dimensional vectors, and to allow during training identification of correlations between values of the non-categorical field and individual values of the lower-dimensionality representation.

17. The non-transitory computer-readable media of claim 14, wherein the hyperparameters identify one or more additional categorical fields within the set of fields, and wherein the hierarchical neural network comprises an additional auxiliary neural network for each of the one or more additional categorical fields, the outputs of each additional auxiliary neural network representing additional inputs to the main neural network.

18. The non-transitory computer-readable media of claim 14, wherein the hierarchical neural network further comprises an intermediary neural network provides the lower-dimensionality representations output by the auxiliary neural network to the main neural network.

19. The non-transitory computer-readable media of claim 18, wherein the intermediary neural network further reduces a dimensionality of the lower-dimensionality representations output by the auxiliary neural network prior to providing the lower-dimensionality representations to the main neural network.

20. The non-transitory computer-readable media of claim 14, wherein the classification is a binary classification.
